(19) United States
(12) Patent Application Publication
(10) Pub. No.: US 2010/0094697 A1
(43) Pub. Date: Apr. 15, 2010

(54) SYSTEM AND METHOD FOR BANKING

(75) Inventor: Gerard V. Cavanaugh, St. David's, PA (US)

Correspondence Address: DORSEY & WHITNEY LLP;INTELLECTUAL PROPERTY DEPARTMENT, 250 PARK AVENUE, NEW YORK, NY, 10177, US

(73) Assignee: ePlanet United, LLC, Wayne, PA (US)

(21) Appl. No.: 12/249,694

(22) Filed: Oct. 10, 2008

(51) Int. Cl. G06Q 30/00; G06Q 40/00

(52) U.S. Cl. 705/14.17; 705/26; 705/40

(57) ABSTRACT

An online banking system and method for a financial institution is provided where a savings account and a spending account is provided for a customer of the financial institution. The customer of the financial institution can receive a discount on one or more goods from an entity other than the financial institution based on one or more criteria provided by the financial institution, such as the value of the savings account. The goods from the entity can be purchased from funds in the spending account, and the amount of the discount can be credited to the savings account.

### FIELD OF THE INVENTION

The present invention relates to systems, processes and computer accessible mediums for banking that promote customer savings, and more particularly to systems, processes and computer accessible mediums which facilitate automatically setting aside savings for customers.

### BACKGROUND INFORMATION

The traditional role of banks has been to make commerce possible over distance and time and to serve a certain community, often determined geographically. Banks encouraged people to save, conserve their assets and become financially secure. The banks were to protect the customers' money through tight security and sound banking processes. Banks lent money for large purchases, but banked on their customers' restraint and financial stability.

In 1980, there were 14,000 banks in the United States of America. Banking was overcrowded, wasteful and not as profitable as investors wanted them to be. During the 1980's, banks started to adopt technology. First, the Automated Teller Machine (ATM) made teller transactions passe. Then computers modernized bank offices and office automation replaced paperwork. Fees became the top choice for many banks. Commercial banks identified savings banks and Savings & Loans (S&L's) as outmoded, outmarketed and out-maneuvered.

Banking changed from a traditional conservative business model where banks lent to people who could safely pay money back and they made money on the spread; thus, banks had to review their risks to make money. The model has since changed, and the new model features high fees, a high rate of interest on credit cards and mortgages sold through wholesalers, who do not look significantly at customers' ability to repay. Banks now desire customers who will pay the most interest and the highest fees, i.e., the middle class. For years, the middle class has been under extreme pressure to overuse easily available customer credit to make their purchases, which in the long run causes them to spend more and save less.

At the present, more people are relying on their credit and borrowed money, and savings has taken a less important role. The concept of disposable income has discouraged savings and urges people to make purchases regardless of income or what they have saved. Since virtual banks were lending to customers on a mailing list, these banks could justify charging more interest because there was more risk.

Credit card fees increased from $1.7 billion dollars in 1996 to almost $18 billion in 2007—an increase of more than a 1000%. There is now a negative savings rate in the U.S. Two thirds of the U.S. population may not be able to pay their credit cards off each month. In the last few years, trillions of dollars have been cashed out of people's homes and much of that went to pay off credit card bills. Although customers want to pay off their debt, more and more customers are borrowing without a savings plan and/or a repayment plan.

A need may, therefore, exist for exemplary embodiments of a banking system, method and computer-accessible medium that can facilitate and encourage the accumulation of savings and help customers save money, budget their finance, control their spending and help customers save as they spend.

### SUMMARY OF EXEMPLARY EMBODIMENTS OF THE INVENTION

An exemplary embodiment of the present invention provides a system, method and computer-accessible medium providing customers of a financial institution an ability to save money and providing for better money management. The exemplary system, method and computer-accessible medium allows customers to save money more easily and encourages savings by increasing the amount of money customers can save through various banking accounts.

In one exemplary embodiment of the present invention, a system for a financial institution is provided, comprising a computer accessible medium which has a software thereon, wherein, when the software is executed by a computing arrangement, the computing arrangement is configured to generate a savings account and a spending account, and to provide for facilitating purchases of one or more goods from an entity other than the financial institution, and wherein the computing arrangement, when executing the software, is further configured to provide to a customer of the financial institution a discount of the one or more goods based on one or more predetermined criteria of the financial institution.

In another exemplary embodiment of the present invention, a system for a financial institution is provided, comprising a computer accessible medium which has a software thereon, wherein, when the software is executed by a computing arrangement, the computing arrangement is configured to generate a savings account and a spending account used by a customer of the financial institution to purchase one or more goods from an entity other than the financial institution, and wherein if a purchase of the one or more goods is made by the customer, the computing arrangement, when executing the software, is further configured to deduct an amount of the purchase from the spending account, and deposit an amount of a discount provided by the entity into the savings account.

Also provided is an exemplary computer method for a financial institution, comprising the step of providing a computer accessible medium which has a software thereon, wherein, when the software is executed by a computing arrangement, the computing arrangement is configured to provide a savings account for a customer of the financial institution, provide a spending account for the customer, and provide a discount for the customer for one or more goods provided by an entity other than the financial institution based on a value of the savings account.

An exemplary computer-readable medium is provided having instructions to cause a processor to execute a method comprising the steps of providing a savings account for a customer of the financial institution, providing a spending account for the customer, and providing a discount for the customer for one or more goods provided by an entity other than the financial institution based on a value of the savings account.

An exemplary system for a financial institution is also provided, comprising a computer arrangement which, when executing a software program embodied on a computer-readable medium encoded with computer executable instructions, is configured to provide a savings account for a customer of the financial institution, provide a spending account for the customer, and provide a discount for the customer for one or more goods provided by an entity other than the financial institution based on a value of the savings account.

Exemplary embodiments of the present invention and aspects of the invention have been described with reference to different subject-matters. In particular, some exemplary embodiments have been described with reference to apparatus type claims whereas other embodiments have been described with reference to method type claims. However, a person skilled in the art will gather from the above and the following description that unless other notified in addition to any combination between features belonging to one type of subject-matter also any combination between features relating to different subject-matters.

These and other aspects of the present invention will become apparent from and elucidated with reference to the embodiments described hereinafter.

### BRIEF DESCRIPTION OF THE DRAWINGS

Further objects, features and advantages of the present invention will become apparent from the following detailed description taken in conjunction with the accompanying figures showing illustrative exemplary embodiments of the present invention, in which:

FIG. 1 is a block diagram for a banking system according to an exemplary embodiment of the present invention;

FIG. 2 is a flow diagram for a banking method according to an exemplary embodiment of the present invention; and

FIG. 3 is a flow diagram for a banking system according to another exemplary embodiment of the present invention; and

FIGS. 4(a)-4(e) are exemplary screen displays provided by an exemplary online banking system, method and computer-accessible medium of the present invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF EXEMPLARY EMBODIMENTS

The present invention pertains generally to tools and methods which allow a customer to easily add funds to one or more savings accounts or other savings vehicles.

In an exemplary embodiment of the present invention, a banking system and method (e.g., which can be used on-line or via a communication system such as the Internet) to assist customers to save their assets (e.g., money), budget their finances, control their spending, save as they spend, practice better money management, etc. By encouraging savings and leveraging the power of actual cash assets, a significant value proposition can be provided that distinguishes it from other web-based and/or traditional banking. By taking advantage of certain online technology to facilitate customers to save more money, to save it more easily and to make it worth more when they spend it, the amount of money customers save can be increased through a variety of, e.g., Federal Deposit Insurance Corporation (“FDIC”)—insured depository banking accounts, which can assist customers avoid high cost consumer credit card borrowing.

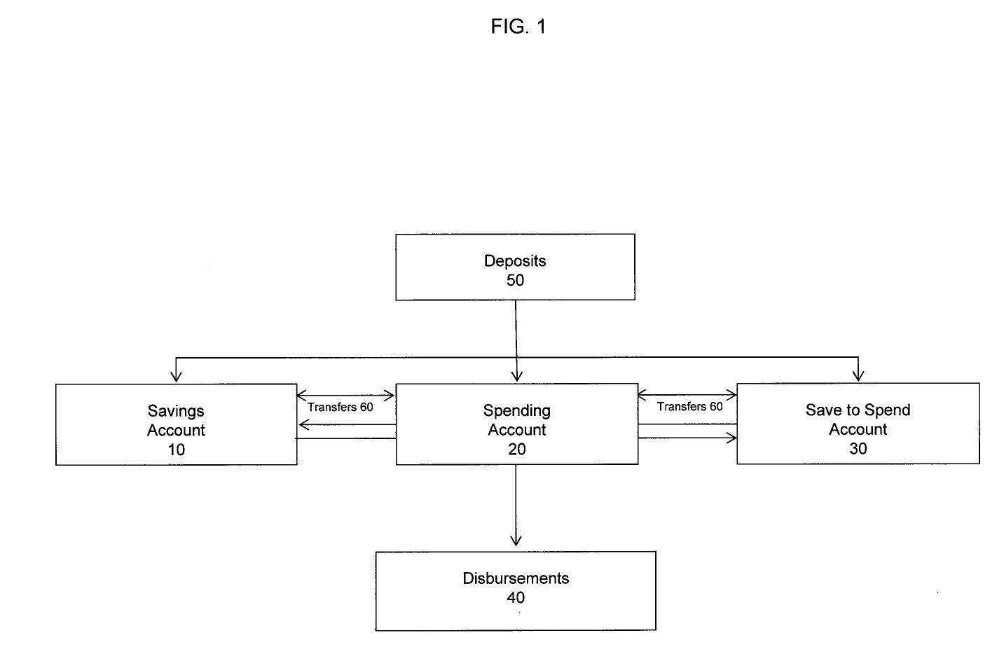

As shown in FIG. 1, the exemplary embodiment of the system according to the present invention can provide, e.g., two of the basic account types which may be a Savings Accounts 10 and a Spending Account 20. The Savings Account 10 can serve as the primary account, and promote personal wealth through financial responsibility. Highly competitive rates of return may be paid on every type of account customers hold, e.g., especially the Savings Accounts 10, which may pay a rate that is higher than the national average. Customers can earn highly competitive rates of return on their Savings Accounts 10, thus encouraging them to save their money first, e.g., before they spend it.

Regular saving can be encouraged and facilitated for the customer, such as through targeted direct mailings. Customers may be invited to establish an automatic savings plan during an online application process by selecting the amount and frequency of a recurring transfer from another bank account and/or a further financial source. Customers can also be paid to use Direct Deposit, with the Savings Account 10 being the default account.

A Spending Account 20 can also be provided, which can be an interest bearing direct deposit account (DDA). To open such exemplary Spending Account 20, a customer would first have the Savings Account 10, and may possibly need to have a minimum amount in the Savings Account 10, although this does not have to be required. This simple organization of accounts can be the first step to assist customers obtain control of their finances. Although it is possible to have no minimum required to open a Savings Account 10 and/or Spending Account 20, once the customer's savings balance in the Savings Account 10 reaches a predetermined threshold, e.g., $1,000.00, a Money Multiplier™ feature of the Spending Account 20 can be triggered, as described in further detail herein below.

For example, the Money Multiplier™ feature of the Spending Account 20 can facilitate certain discount pricing available to customers who may shop via, e.g., preferred merchant websites or stores, leveraging their cash balance in the Spending Account 20 for exclusive real dollar discounts for online and in-store purchases. In an exemplary embodiment of the present invention, only customers who maintain a threshold balance, e.g., $1000.00, in the Savings Account 10 may qualify for certain exemplary Money Multiplier™ discounts. For example, a preferred merchant can be any merchant selected by the financial institution for a working relationship. The preferred merchant web site may be entered by the customer through a link on the web site of the financial institution. Discounts can differ based on, e.g., the merchant, the balance of the Savings Account 10, how long the customer has been a customer of the financial institution, the balance of the spending account 20, and/or other criteria. Purchases can be deducted from the Spending Account 20.

In addition, the Spending Account 20 can act as a web portal to preferred merchant network affiliates, likely producing a significant advertising revenue. The preferred merchant network of retailers, manufacturers and service providers can produce significant monetary results. In addition to those discounts from merchants, customer shopping discounts can be subsidized by the financial institution with a fraction of the advertising revenue stream created by the Spending Account web portal.

For example, advertising revenue can include click throughs and conversion commissions. The volume of online shopping transactions made through the preferred merchant network partner websites can be routine purchases of goods and services, such as appliances, apparel, food, and travel. However, in large ticket purchases, such as automotive and housing, opportunities can be utilized to assist customers save considerable money, facilitate business to the partners, and possibly provide a substantial revenue and profit. Home mortgages, home equity loans, auto loans and business loans can all be provided in such manner.

A customer visiting a preferred merchant auto dealer, for example, either in person or online through the Spending Account web portal, can be provided with an attractive discount available on the automobile model selected, thus generating a conversion commission and enabling a bank to finance the purchase. New homes purchases can be handled in a similar manner. For example, customers may obtain a special discounted price when purchasing a new home from regional and national builders who may be within the preferred merchant network and then finance the purchase with a competitive mortgage rate through a preferred mortgage broker.

Other venues are provided for revenue generation that can be advantageous to the preferred merchant. For example, when a customer accesses the preferred merchant's web site through the web site of the financial institution, the financial institution can generate revenue for each click for each merchant's webs site that the customer visits (preferred merchant will pay the financial institution per click or per visit from each customer). Further, additional revenue can be generated if the customer purchases the item from the preferred merchant (e.g., the preferred merchant can pay the financial institution a set amount, a percentage of the value of the item purchased, etc.).

An exemplary benefit can also be provided to the preferred merchant. For example, with respect to the amount of revenue that may be generated by the financial institution for each click on the preferred merchant's web site (preferably through the web portal of the financial institution), that amount can be credited against the amount of advertising revenue earned by the financial institution from the preferred merchant if the customer indeed purchases the item. A time criteria may also be added where the credit is given to the preferred merchant only if the customer purchases the item within a certain amount of time after viewing the item.

According to the exemplary embodiment of the present invention, customers who maintain a minimum a threshold balance in their Savings Account 10 can qualify for the Money Multiplier™ discount when they make purchases from the affiliated retail affiliates through their Spending Account 20. The available cash balance in the Spending Account 20 can be leveraged at the point-of-sale for actual dollar discounts on the transactions with affiliates for, e.g., apparel, cars and food to home improvement, consumer electronics, travel, etc. For example, customers can view the value of the discounts before buying.

Maintaining incrementally greater savings balances can increase the rate of return on the Savings Account 10, as well as the size of the shopping discounts through the affiliates. In addition to this exemplary incentive which can link customers' spending power to saving, customers can be offered greater value through account linking and automated distribution of deposits into, e.g., special Save to Spend Accounts 30 (as shown in the exemplary embodiment of FIG. 1) that customers specify when they set up their account preferences and control in their day-to-day activity. For example, the Save to Spend Accounts 30 can be interest-bearing accounts earmarked for vacation, tuition, holiday shopping, healthcare or other long-term, high-ticket purchases. Customers can automate their budgeting by designating scheduled direct deposit of preset amounts to these special accounts. These accounts may be subsets of the Spending Account 20, and customers can have a number of such Save to Spend Accounts 30.

When customers make a purchase through the preferred merchant network, customers can receive, e.g., an immediate notification of their completed debit transaction, including account reconciliation information. An online pop-up cue can facilitate the customers to re-direct a portion of the amount they saved on their purchase from their Spending Account 20 into their Savings Account 10. This exemplary feature can be called the Money Magnifier™. The customers may decide to use this feature to pay down their home mortgage, or to purchase shares in a stock fund. Customers benefit from financial control in this new value chain and/or take advantage of their buying power through the communication network, such as the Internet, on a desktop, laptop, PDA, cell phone or WiFi network, online, through dedicated POS kiosks that enable banking transactions as well as purchases with affiliates, etc.

In addition to the website which facilitates customers to manage their personal finances and save money on transactions, the Spending Account 20 can also be used as a web portal linked to affiliates' websites in the preferred merchant network. A revenue stream can be derived from the online advertising.

Certificates of Deposit (“CDs”)can be provided for customers with mid to long term savings instruments, e.g., suited for early stage wealth management. Although they come at a higher cost to the financial institution, CDs can provide the fixed rate capital necessary for mid to long-term lending support.

Direct Deposit can be provided for customers to put money into their account. A premium can be paid to new depositors when they open their account with direct deposit and bonus that premium at the end of the first year.

Cost avoidance can be one exemplary byproduct of enhancing customer value through direct bill payment according to the exemplary embodiment of the present invention. Customers can be actively encouraged to pay bills through direct disbursement. This exemplary feature can assist customers be current and may facilitate a reduction of check-clearing operations and costs to a negligible level. For a direct disbursement customer with an occasional payee who does not accept online payments, the payment information can be obtained from the customer, and a paper check can be issued and mailed, postage included.

The Savings Account 10 of FIG. 1 can provide various features, such as one or more of, e.g.,:
FDIC-insured Savings account.
Add money through direct deposit, mail or any ACH transfer.
High yields with the ability to access funds.
With a threshold balance (e.g., $1,000.00) in this account customer qualifies for partner discounts at time of purchase.
The more a customer keeps on deposit in savings, the greater the return and the deeper the discount when shopping with partners through a Spending Account. (e.g., incremental increases, from $1,000, $2,500, $5,000, $10,000, $25,000 to $100,000).
Free SMARTCard/Debit card.
No minimum balance required to earn interest.
Interest compounded daily and credited monthly.
Minimum opening deposit (e.g, $100.00).
Easy online application. Customer can opt to add a Spending Account at the same time.
Access an account online or at more than one million ATM locations.
No monthly service charge.
Email alerts. Free, detailed account information to a customer's inbox.

The exemplary Spending Account 20 can also provide for various features, and may facilitate a different feature from other financial institutions. The Spending Account 20 provides for saving before a customer spends the funds. This is can be the customer's DDA account. Although it is likely an interest bearing money market account with its main purpose being disbursement, it can provide certain exemplary features. The Spending Account 20 can provide the customers a unique opportunity to save when making purchases through the preferred merchant network, which can use the financial institution's web site as the portal to the merchant's website. The financial institution can negotiate shopping discounts with these partners to leverage the available cash balance to an amount greater than the actual dollar amount in the customer's Spending Account 20. As indicated above, this can be the Money Multiplier™ feature. The Spending Account 20 can facilitate, e.g., one or more of the following:
Preference of the Savings Account 10 to obtain the Spending Account 20. (e.g., $1,000 minimum in Savings required to activate Money Multiplier discounts).
Money Market rates such as an interest bearing DDA.
No minimum balance to earn interest.
the Spending Account 20 may also be a portal that links to preferred merchant sites for exclusive discounts at point of purchase. This creates a click-through and conversion advertising revenue component.
As the customer's retail transaction has been completed and the account debit advice and reconciliation is, e.g., immediately sent to the customer, they are simultaneously prompted to move the amount saved or a portion thereof from the Spending Account 20 to the Savings Account 10.
Customers may redirect all or any portion of their transactional savings from purchases made from their Spending Account 20 through any preferred merchant to any of their Savings Accounts 10. This Money Magnifier™ exemplary feature can assist the customers to increase the amount of their savings principal.
With this Money Magnifier™ exemplary feature, all, some or none of the discount amount saved on purchases can be directly deposited by the customer into their Savings Account 10 (e.g., a customer purchases a large plasma TV from one of the merchant partners with a retailer price $2,300, the bank's discount price is $2,050, for a member savings of $250. A customer can elects to direct 10% of savings of $25 to the Savings Account, or any other portion thereof.
Customers may also decide to direct any portion of their savings to a Stock Fund (e.g., an Investment Account managed by the bank's investment management group).
Customers may select to direct any portion of their savings to their mortgage to accelerate the payoff of their mortgage loan.
Free on line bill paying through Direct Debit for recurring or one-time bills.
Direct Disbursements—e.g., Direct debits for utility payments, mortgages, savings plans and other recurring expenses can be the default payment method. Once a customer enrolls in direct disbursement from their Spending Account, the bank can offer a unique supplementary payment method for those customers that require paper checks for certain bill payments.
No monthly account fees.
Simple to start, initial deposit can be through mail, Internet, telephone, wire transfer.
Free SMARTCard/Debit Card Linked to Spending Account
Free email alerts

One or more of the Save to Spend Accounts 30 can also be provided, which can facilitate one or more of the following exemplary features:
Automated Direct Deposit of a portion of payroll into an unlimited number of Special Accounts for a dedicated planned spend.
Adults and children can learn to save for a special item. Parents can encourage their children to increase their savings by a fund-matching incentive that starts the habit of spending one's own money, not borrowed money early on for vacation savings, holiday shopping, education accounts, health care accounts, videogame accounts, ipod® accounts, other (customized) accounts.
Special Accounts customer can set up according to life stage/life style.
Channel automatic deposits when through account preferences or manually with each transaction.
may pay more than a regular Spending Account 20.
Earns interest well over the national average.
No monthly account fees.
No minimum balance to earn interest.
Easy to start, initial deposit can be through mail, Internet, telephone, wire transfer.
Linked to SMARTCard/Debit Card
Free email alerts

For example, Deposits 50 can be made into the Savings Account 10, the Spending Account 20, and/or the Save to Spend Account 30. Disbursements 40 can be provided through the Spending Account 20. Transfers 60 can be made between the Savings Account 10, Spending Account 20, and the Save to Spend Account 30.

Other various accounts can also be provided, such as an investment account. In addition to traditional insured bank deposit accounts, such as checking, savings, and certificates of deposit, these accounts can provide a number of non-depository investment choices. Unlike traditional bank deposit products, these non-depository investment products may likely not be insured. Some examples of investment innovation can include one or more of:
Preferred Merchant Stock Fund.
Invest in a mutual fund made up of the stocks of affiliates.
Partners include retailers, manufacturers and service companies.
No Load low maintenance cost.
Linked for automatic or opt-in direct investment to Savings and Spending Accounts.
Easy to start, initial deposit can be through mail, Internet, telephone, wire transfer.
Free email alerts.

Other investment accounts can include annuities, mutual funds, stocks/bonds, government securities, municipal securities, and U.S. Treasury securities.

The financial institution can use a combination of rules and real-time predictive analytics to make relevant cross-sale offers when appropriate, to the customers during inbound telephone, permission based email, and web site interactions. A significant amount of the growth in account relationships can be provided through a well-trained and motivated call center.

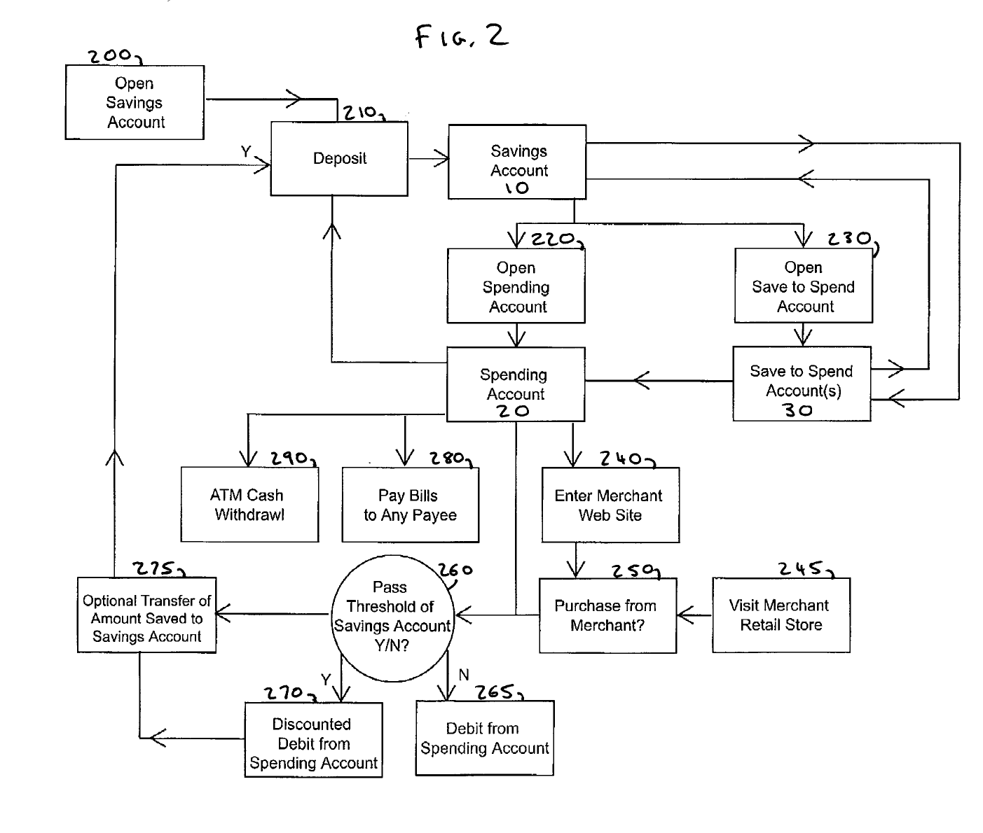

An exemplary embodiment of the method according to the present invention is shown in FIG. 2. For example, in step 200, a Savings Account is first opened by a customer with the financial institution. At step 210, a deposit can be made by a customer to a financial institution in the Savings Account 10. The deposit may be initially entered into the Savings Account 10 at step 210. Once the customer opens a Savings Account, deposits can be made into any account.

A customer can then be asked if he/she would like to open a Spending Account 20 at step 220. If not, the method can end or return to the initial step 210 until another deposit is made. If the customer would like to open a Spending Account 20, then a Spending Account 20 is opened at step 220. Once a Spending Account 20 is open, or after the customer opens just a Savings Account 10, the customer can be asked if they would like to open up one or more Save to Spend Accounts 30 at step 230. If not, the process can return to the initial step 210 or back to step 220. If the customer would like to, then one or more Save to Spend Accounts 30 can be opened at step 230.

Once the Spending Account 20 is open, an ATM withdrawal can be made at step 290 or the Spending Account can be used to pay any bills to any payee at step 280. These bills can be items the customer owes the financial institution (credit cards, loans, etc.), items owed to any preferred merchants, and/or any accounts by third parties that the financial institution pays on behalf of the customer.

Once a Spending Account 20 is open at step 230, the next step can also be to determine if the customer would like to enter a web site of a preferred merchant at step 240. If not, the process repeats and reverts to the initial step of making a deposit 210 or back to the Spending Account 20, where the customer can later return to enter the web site of a preferred merchant at step 240 or open a Save to Spend Account 30 at step 230. If the customer wants to browse the merchant sites, the customer is forwarded to a web portal from a financial institution's web site to the merchant of the customer's choice at step 240, where the customer can select which merchant's site to visit and then the item(s) they would like to purchase, as described above. The customer can also visit a merchant retail store at step 245 instead of visiting a web site.

If the customer desire to make a purchase from the merchant at step 250, the customer can be shown the retail price of the item and the savings associated by purchasing it from the preferred merchant through the financial institution's web site. This is the exemplary Money Multiplier™ feature of the Spending Account 20. At step 260, according to the exemplary embodiment of the method, it is possible to determine if the amount in the Savings Account 10 passes over a certain threshold which the financial institution can request or require the customer to have before allowing for a discounted purchase from a preferred merchant. A purchase can always be made from a merchant using the Spending Account, but to encourage savings, a discounted purchase is only allowed in a preferred embodiment if the amount in the Savings Account 10 passes a certain threshold.

If the amount in the Savings Account 10 is over the threshold, then a discounted purchase is allowed from the merchant at step 270. If the amount in the Savings Account 10 is not over the threshold, then a purchase is allowed from the merchant at step 265 without the discount. The amount of the purchase is debited from the Spending Account 20. If a discounted purchase is made, the purchase price amount of the item (with the discount savings associated thereof) is deducted from the Spending Account at step 270. It is then reported to the customer how much the customer saved by purchasing the item through the preferred merchant than if the customer bought it at the retail price.

At step 275, the customer can be asked if the savings should be deposited into the Savings Account 10. If not, the savings remain in the Spending Account 20. If the customer agrees, then the savings are deposited into the Savings Account 10. Although at step 270, only the amount paid by the customer to the merchant can be deducted from the Spending Account 20 (retail price minus savings), the purpose is to help customers save. Therefore, the amount of the savings based on a retail purchase can be deposited into the Savings Account at step 275. Thus, although the customer may see the same amount deducted from the Spending Account he/she would have paid at retail price, a savings amount is deposited into the Savings Account 10 so the customer realizes and appreciates the savings amount. This is the exemplary Money Magnifier™ feature of the Spending Account.

The customer can also choose to deposit the savings amount into one or more Save to Spend Accounts 30 or to pay any bills (not shown). These bills can be items the customer owes the financial institution (credit cards, loans, etc.), items owed to any preferred merchants, and/or any accounts by third parties that the financial institution pays on behalf of the customer.

Initial deposits 210 for account initiation can be made easily through the Internet, telephone, fax, wire transfer, USPS mail or through the financial institution's partners' own P.O.S. terminals. An easy-to-follow process makes deposits convenient and secure. The customers can be encouraged through cash incentives to establish a direct deposit relationship with the financial institution for payroll, dividends, annuities, refunds and rebates. When the customers set their account preferences, they can allocate direct deposits to cascade to the Savings, Spending, Save to Spend Accounts, retirement funds or even loan accounts.

The financial institution's website can facilitate customers to have a safe, secure, easy and convenient way for them to move money from account to account, to access their credit lines, and to assume a proactive role in managing their own assets. As the customers set up their account preferences, the initial recommendation can be savings first, then spending.

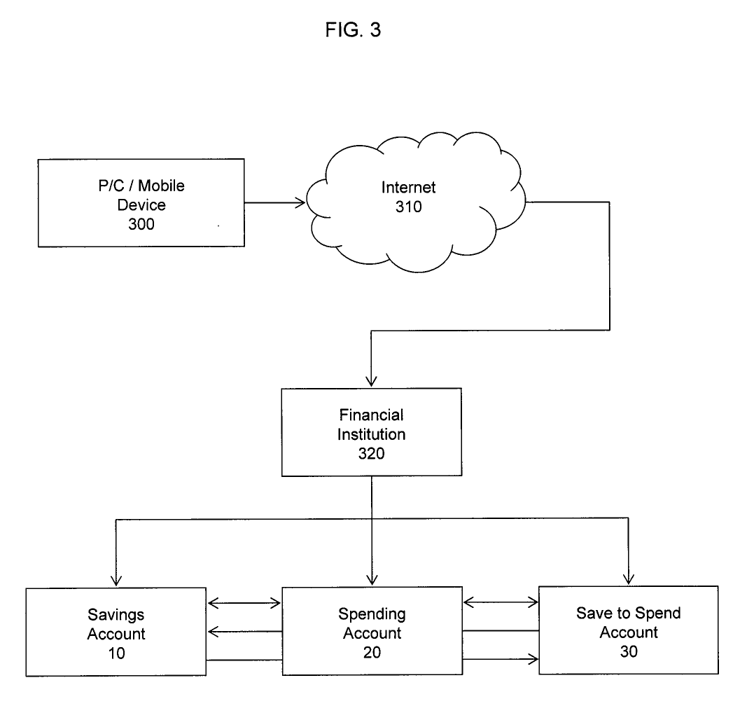

As seen in the exemplary embodiment shown in FIG. 3, the customer can use a personal computer or mobile device 300 to connect to the Internet 310. The connection can be made through a wireless network or through a LAN connection, as is known in the art. The customer can connect to the web site of the Financial Institution 320, through which it obtains access to its accounts. Access can be made through the financial institution's web site to the customer's Savings Account 10, Spending Account 20 and/or one or more Save to Spend Account(s) 30 via a safe and secure connection, as is known in the art. As described above, transfers can be made between the Savings Account 10, Spending Account 20 and/or one or more Save to Spend Account(s) 30. The exemplary method shown in FIG. 2 can be provided through the system described herein in FIG. 3. It should be understood that the exemplary embodiments of the systems shown in FIGS. 1 and 3 and the method shown in FIG. 2 can be executed using software which can be stored on a computer-accessible medium (e.g., hard drive, RAM, ROM, floppy drive, CD-ROM, memory stick, any memory of storage device, etc., and/or or combination and/or multiple thereof), and executed by a processing arrangement (e.g., a microprocessor, a computer, etc.).

The accounts can be an on online business for the financial institution, with no physical retail banking locations, so customers can access their accounts through a variety of web-based end points: For example, desktop computer, laptop, cell phone, PDA, at a CyberCafe or site-specific kiosks linked to partners' point-of-sale terminals. Cash will be available through ATM partnerships.

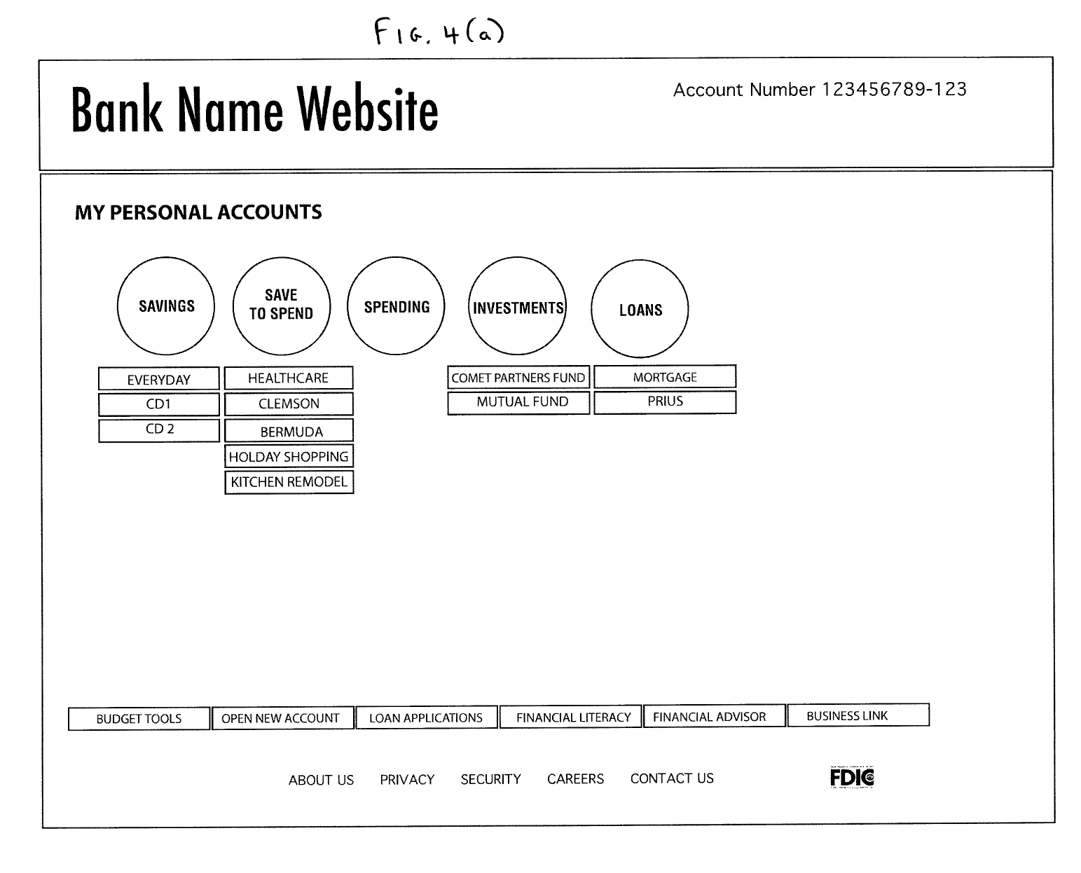

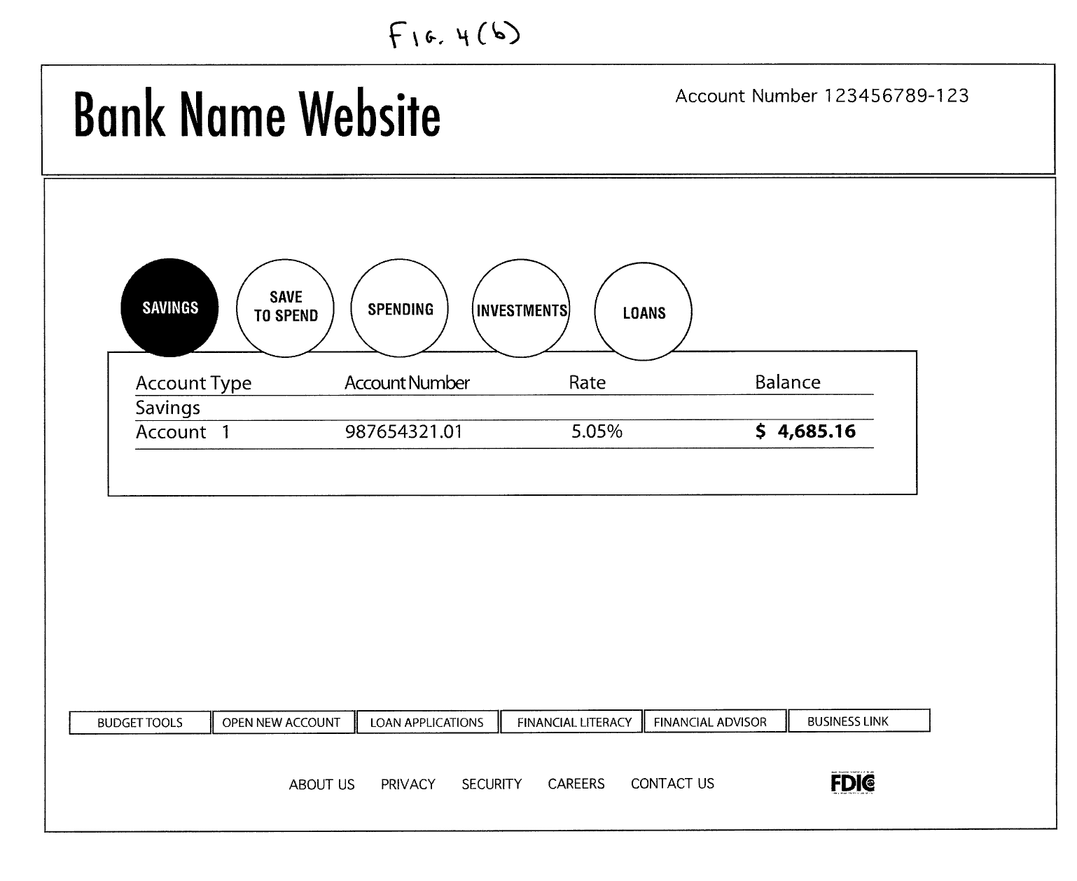

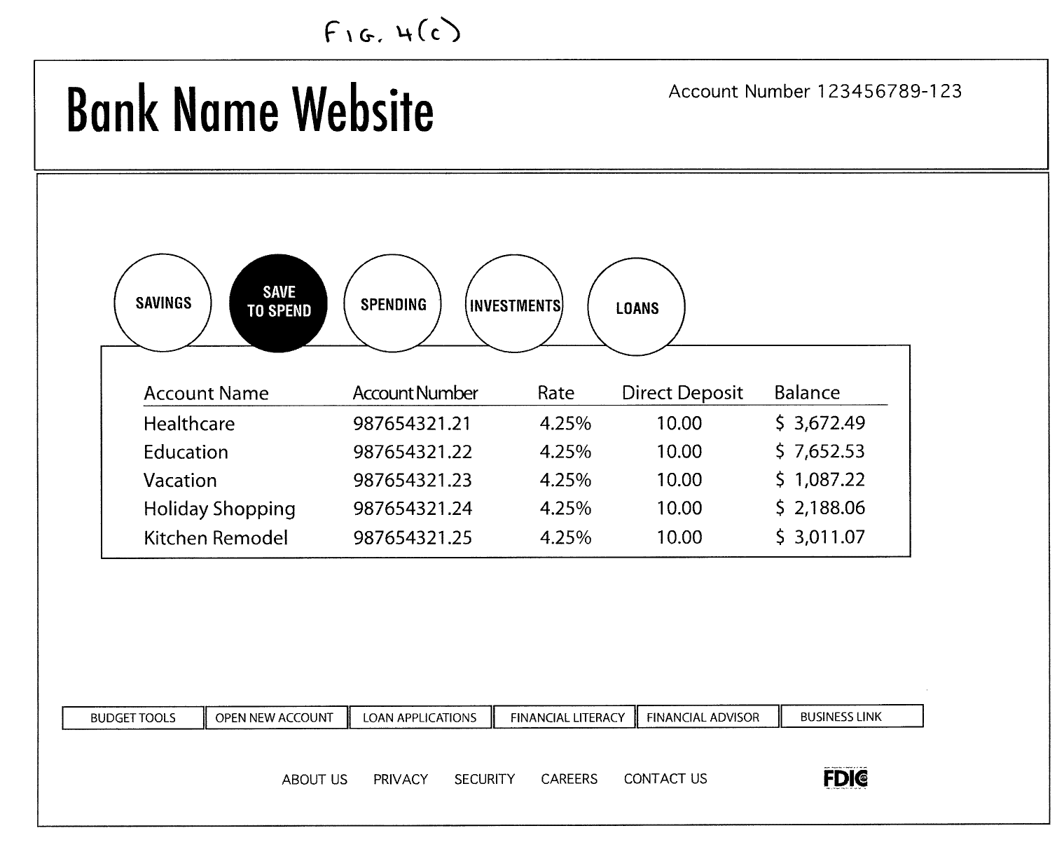

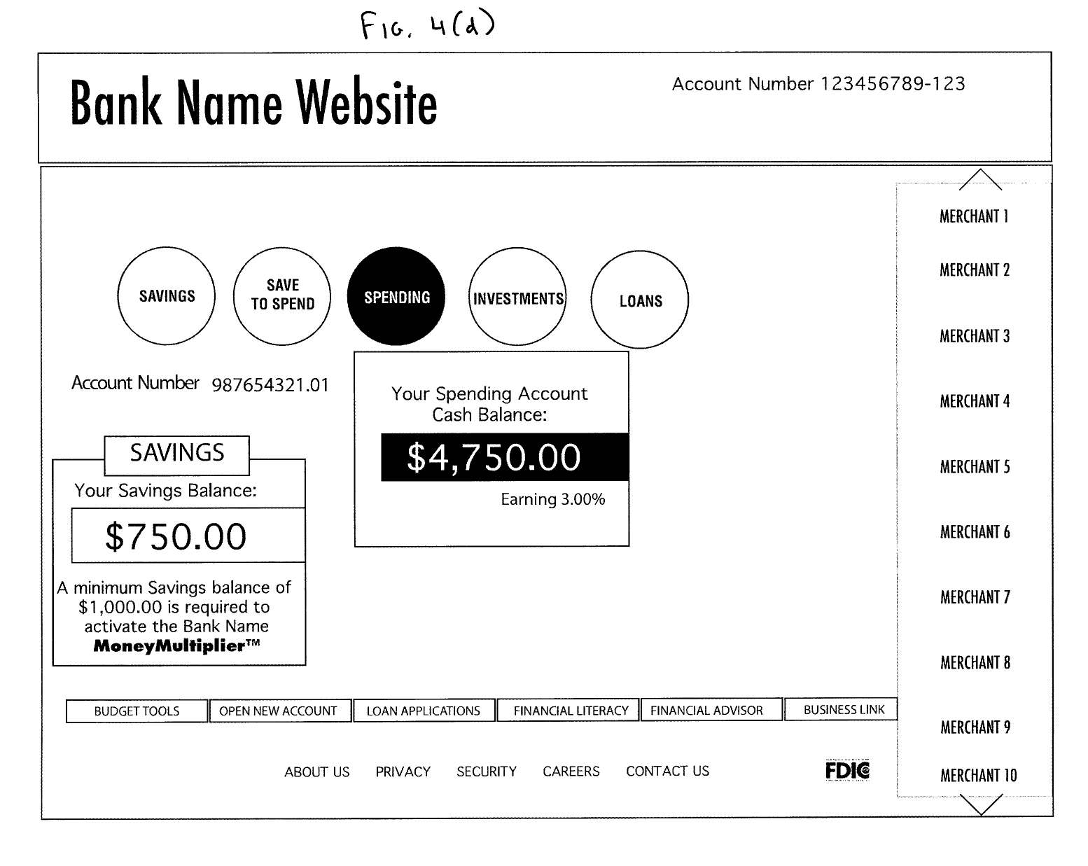

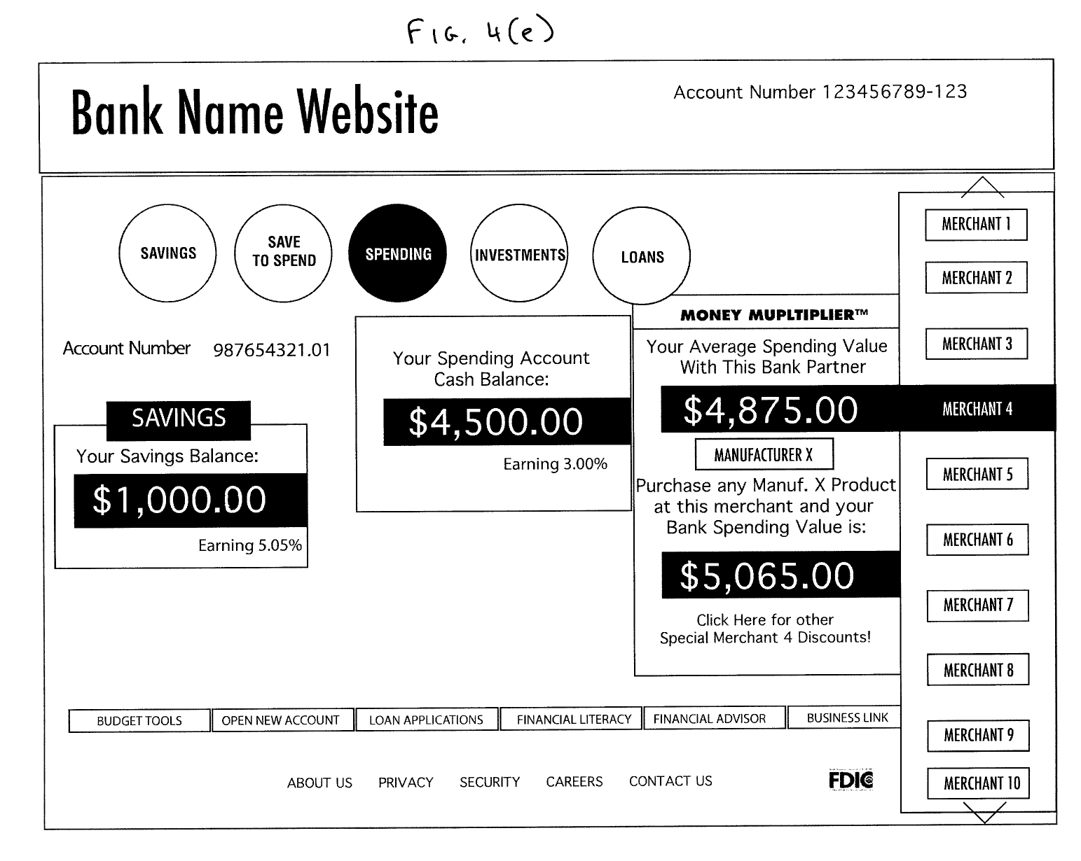

For example, FIGS. 4(a)-4(e) illustrate exemplary screen shots of an exemplary embodiment of an online banking method according to the present invention. A customer can visit the bank's web site as a customer or a visitor. The visitor section of the web site can provide the customer information about the different accounts as set out above, information on the preferred merchants, rates, etc. The customer can use a secure online connection and enter his/her personal account information (username, password, etc.) to sign on and see their one or more accounts with the financial institution.

FIG. 4(a) shows an example where a customer has a savings account (CD's included), a Spending Account, various Save to Spend Accounts, Investments and Loans. The customer can click on the button for any of these accounts to see more detailed information on these accounts, including balance or payoff amounts, scheduled payments, investment information, etc.

For example, if the customer clicked on the “Savings” button, he/she would see the screenshot as provided in FIG. 4(b), showing the amount, account number, rate percentage and balance. If the customer clicked on the “Save to Spend” button, he/she would see the various Save to Spend accounts, the account numbers, rate, and balances. If the customer clicked on the “Spending Account” button, he/she would see the amount of their Savings Account and Spending Account, and a list of merchants on the right side through which they can make a purchase on a discounted item.

For example, as shown in the exempla of FIG. 4(d), the Savings Account has a balance of $750.00, and the Spending Account has a balance of $4,750.00. The financial institution can have a requirement of a minimum threshold in the Savings Account 10 of $1,000.00 for enabling discount Money Multiplier purchases, and the customer would have to transfer money into the Savings Account before being able to make a discounted purchase through the merchant network. The merchant web sites would not be available unless the Savings Account 10 has the minimum amount of savings required. Once the customer transfers $250.00 from the Spending Account into the Savings Account, acquiring a balance of $1,000 in the Savings Account and a balance of $4,500.00 in the Spending Account, as shown in FIG. 4(e), the customer would be provided access to the links for the merchants' web sites to enter the merchants' web sites and browse items and/or make a purchase of an item. This feature is part of the Money Multiplier™ discount of the present invention.

Online posting can be the default mode for customer account statements, with a consolidated summary providing a comprehensive overview of their total relationship with the financial institution. Free email account statements may be the customer's first option, with mailed printed statements available at no additional charge. Statements will summarize banking activity on all accounts for the month, showing Savings, Spending, Save-to-Spend, Loans and Credit Lines in one. Spending account activity can note transactions and discounts earned with the partners.

For convenience, some of the terms used in this document are defined here. However, these definitions must be viewed in the context of the entire document, and these and other terms are defined at least in part by examples given throughout this document. “Financial institution” can include at least banks, online banks, credit unions, credit card companies, brokerage houses, and other organizations which are subject to banking and/or securities laws and/or regulations. In particular, debit cards, smart cards, checking accounts, and the like are issued by the financial institution. Likewise, savings accounts, certificates of deposit, mutual funds, and other savings vehicles are provided by the financial institution. “Merchants” in general are not necessarily financial institutions. Saving Accounts, Spending Accounts and Save to Spend Accounts can include monetary balances, cash, cash equivalents, mutual funds, certificates of deposit, money-market accounts, and other investment accounts. “Value” can include cash, cash equivalents, or other negotiable instruments or negotiable assets such as stock shares or bonds. They may be taxable, tax-deferred, or tax-free. In some embodiments, value can include mortgages, lines of credit, consumer loans, and similar accounts. The transactions contemplated under the invention include at least electronic transactions and cash transactions.

The invention may be implemented using legal agreements; electronic funds transfer tools and techniques; computer software, hardware, and networks; and other tools and techniques. Many conventional tools and techniques can be adapted for use according to the invention, such as those conventionally used to manage credit card accounts, funds transfers, inquiries from credit card holders, and so on.

It should be noted that the term “comprising” does not exclude other elements or steps and the “a” or “an” does not exclude a plurality. Also elements described in association with different embodiments may be combined.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention.

What is claimed is:

1. A system for a financial institution, comprising:
a computer accessible medium which has a software thereon, wherein, when the software is executed by a computing arrangement, the computing arrangement is configured to generate a savings account and a spending account, and to provide for facilitating purchases of one or more goods from an entity other than the financial institution, and
wherein the computing arrangement, when executing the software, is further configured to provide to a customer of the financial institution a discount of the one or more goods based on one or more predetermined criteria of the financial institution.

2. The system of claim 1, wherein the criteria comprises a predetermined threshold of a value of the savings account.

3. The system of claim 1, wherein the computing arrangement, when executing the software, is further configured to provide to a customer of the financial institution a discount of the one or more goods based on an agreement with a merchant or a group of merchants.

4. The system of claim 1, wherein the computing arrangement, when executing the software, is further configured to charge a first fee by the financial institution to the entity based on a web site view initiated by the customer of the one or more goods.

5. The system of claim 4, wherein the computing arrangement, when executing the software, is further configured to charge a second fee by the financial institution to the entity based on an online purchase initiated by the customer of the one or more goods.

6. The system of claim 5, wherein the computing arrangement, when executing the software, is further configured to credit the first fee to the entity if the one or more goods are purchased by the customer.

7. The system of claim 1, wherein the computing arrangement, when executing the software, is further configured to provide one or more save to spend accounts for saving for a particular item that is desired to be purchased by the customer at a later time.

8. The system of claim 1, wherein the computing arrangement, when executing the software, is further configured to deposit an amount of the discount to the savings account.

9. The system of claim 1, wherein the computing arrangement, when executing the software, is further configured to credit an amount of the discount to an account of the customer other than the spending account.

10. A system for a financial institution, comprising:
a computer accessible medium which has a software thereon, wherein, when the software is executed by a computing arrangement, the computing arrangement is configured to generate a savings account and a spending account used by a customer of the financial institution to purchase one or more goods from an entity other than the financial institution;
wherein if a purchase of the one or more goods is made by the customer, the computing arrangement, when executing the software, is further configured to deduct an amount of the purchase from the spending account, and deposit an amount of a discount on the purchase provided by the entity into the savings account.

11. The system of claim 10, wherein the computing arrangement, when executing the software, is further configured to allow the discount on the purchase once a threshold for a value of the savings account is achieved.

12. The system of claim 10, wherein a proportional relationship exists between an amount of the discount and a value of the spending account.

13. The system of claim 10, wherein the computing arrangement, when executing the software, is further configured to provide one or more save to spend accounts for saving for a particular item that is desired to be purchased by the customer at a later time.

14. The system of claim 10, wherein the computing arrangement, when executing the software, is further configured to charge a first fee by the financial institution to the entity based on a web site view by the customer of the one or more goods.

15. The system of claim 14, wherein the computing arrangement, when executing the software, is further configured to charge a second fee by the financial institution to the entity based on the purchase by the customer of the one or more goods.

16. The system of claim 15, wherein the computing arrangement, when executing the software, is further configured to credit the first fee to the entity if the one or more goods are purchased by the customer.

17. A computer method for a financial institution, comprising the step of:
providing a computer accessible medium which has a software thereon, wherein, when the software is executed by a computing arrangement, the computing arrangement is configured to provide a savings account for a customer of the financial institution; provide a spending account for the customer; and provide a discount for the customer for one or more goods provided by an entity other than the financial institution based on a value of the savings account.

18. The computer method of claim 17, wherein the computing arrangement, when executing the software, is further configured to fund a purchase made by the customer of the one or more goods from the spending account.

19. The computer method of claim 18, wherein the computing arrangement, when executing the software, is further configured to deposit an amount of the discount in the savings account.

20. The computer method of claim 18, wherein the computing arrangement, when executing the software, is further configured to deposit an amount of the discount to an account of the customer other than the savings or spending account.

21. The computer method of claim 17, wherein a proportional relationship exists between an amount of the discount and the value of the savings account.

22. The computer method of claim 17, wherein the computing arrangement, when executing the software, is further configured to allow the discount on the purchase once a threshold for a value of the savings account is achieved.

23. The computer method of claim 17, wherein the computing arrangement, when executing the software, is further configured to provide one or more save to spend accounts for saving for a particular item that is desired to be purchased by the customer at a later time.

24. The computer method for a financial institution of claim 17, wherein the computing arrangement, when executing the software, is further configured to charge a first fee by the financial institution to the entity based on a web site view by the customer of the one or more goods.

25. The computer method for a financial institution of claim 24, wherein the computing arrangement, when executing the software, is further configured to charge a second fee by the financial institution to the entity based on an online purchase by the customer of the one or more goods.

26. The computer method for a financial institution of claim 25, wherein the computing arrangement, when executing the software, is further configured to credit the first fee to the entity if the one or more goods are purchased by the customer.

27. A computer-readable medium having instructions to cause a processor to execute a method comprising the steps of:
providing a savings account for a customer of the financial institution;
providing a spending account for the customer; and
providing a discount for the customer for one or more goods provided by an entity other than the financial institution based on a value of the savings account.

28. A system for a financial institution, comprising:
a computer arrangement which, when executing a software program embodied on a computer-readable medium encoded with computer executable instructions, is configured to:
provide a savings account for a customer of the financial institution;
provide a spending account for the customer; and
provide a discount for the customer for one or more goods provided by an entity other than the financial institution based on a value of the savings account.
